(19) United States
(12) Patent Application Publication
(10) Pub. No.: US 2008/0155165 A1
(43) Pub. Date: Jun. 26, 2008

(54) Computerized multiple input/output system combined with USB hub and wireless communication functions

(75) Inventors: David Mei, Forest Hills, NY (US); Jin-Xia Bao, Forest Hills, NY (US); Si Ping Bao, Forest Hills, NY (US)

Correspondence Address: COLLARD & ROE, P.C., 1077 NORTHERN BOULEVARD, ROSLYN, NY, 11576, US

(73) Assignee: Cyber Group USA, Inc.

(21) Appl. No.: 11/998,070

(22) Filed: Nov. 28, 2007

Related U.S. Application Data
(60) Provisional application No. 60/875,882, filed on Dec. 20, 2006.
(60) Provisional application No. 60/899,969, filed on Feb. 7, 2007.

(51) Int. Cl. G06F 3/00

(52) U.S. Cl. 710/316

(57) ABSTRACT

A computerized multiple input/output system in which a computerized input device with a computerized hub system and a wireless communication hub inside create a mini-computerized communication command operation center by simultaneously and synchronously communicating with a computerized host device, a wireless handheld controller, and any computerized hub driven extensions that are connected to the computerized input device or controller.

### CROSS REFERENCE TO RELATED APPLICATIONS

Applicants claim priority under 35 U.S.C. §119(e) (1) and the benefit of copending U.S. Provisional Application Ser. Nos. 60/875,882, entitled “Computerized multiple input/output system combined with USB hub and wireless communication functions,” filed Dec. 20, 2006, and 60/899,969, entitled “Computerized multiple input/output system combined with USB hub and wireless communication functions,” filed Feb. 7, 2007, which are incorporated by reference herein.

### BACKGROUND OF THE INVENTION

1. Field of the Invention

The invention relates to a computerized multiple input and output (“I/O”) command operation system, which not only has a computerized input device with a computerized hub system and wireless communication hub inside, but also use those hub systems to create a mini computerized communication command operation center by communicating with a computerized host device, a wireless I/O device instantly, simultaneously, and synchronously for multiple computerized input/output command systems and all computerized hub driven extensions.

2. The Prior Art

It is known to couple a universal serial bus (“USB”) port or hub into an input device like a keyboard or peripheral or dock that is communicating through a cabled or wireless connection to a computer host.

Matias Corporation produces a USB 2.0 keyboard and mouse with USB 2.0 dock and 2 port hub. The keyboard features a tab key on the numeric keypad and control key where the caps lock key is generally located. The keyboard also features a 2-Port USB 1.1 hub and an integrated USB 2.0 dock for high-speed data transfer. Also included with the bundle is a standard 2-button optical mouse with scroll wheel.

Toshiba also produces a USB slim keyboard with 2-Port USB hub. Also, Targus and Keytronic produce similar USB keyboards with USB hubs.

It is also known to couple a USB port into a mouse pad; however, manufacturers simply put a USB port into those devices merely as an adapter, peripheral or dock. Shenzhen Nicey Electronic Co., Ltd. produces a mouse pad with USB hub and multi sockets having one upstream port and four downstream ports.

Another manufacturer produces a wireless mouse that has a base combined with a USB hub. The USB hub is combined only into the base and not into the wireless mouse.

Another product is a mouse with an external USB hub attached to the connecting end of a mouse cable line. The external USB hub is connected to a cable line connecting just the outside of the mouse and a computer; it is not connected on the inside of the mouse.

There are many inconveniences with those simple combinations. First, there are many keys and buttons in the keyboard which already requires a large space for operation. To combine a USB port or USB hub into a keyboard will require more space and a more complicated structure. Second, a mouse pad is no longer widely used because of the popularity of the light- or laser-driven mouse; however, a mouse pad is still useful for old mechanical-driven mice. Third, a wireless mouse base with a combined USB hub requires additional table space. Fourth, the USB hub connected to the outside cable line of the mouse is not convenient to use, store, and carry.

Gateway Inc.'s U.S. Pat. No. 6,933,919 develops another computer pointing device that solely employs memory for data storage. The pointing device may be linked to multiple computers wherein the connection to the pointing device may be toggled from one computer to another or physically moved from one computer to another by using a USB port on a computer system.

In U.S. Pat. No. 7,119,791, a mouse has a casing body that provides a space on its exterior for housing a data storage medium therein. A data processor communicates data between the personal computer and the data storage medium housed in the casing body.

For USB development, U.S. Pat. No. 6,363,491 discloses a USB apparatus and a USB hub apparatus that is connected to a host computer, wherein the USB apparatus and the host computer communicate with each other. These devices include a power supplying means for supplying power to each section of the USB apparatus, power supply voltage detecting means for detecting the presence/absence of a power supply voltage to be supplied from the host computer, and supply power control means in accordance with a detection result of the power supply voltage detecting means.

U.S. Pat. No. 6,725,302 also shows a wirelessly communicating USB hub which aims to provide communication between an I/O device connected to a wirelessly communicating USB port and a wireless communication hub connected to a host computer. The I/O device can then be located in a different room or office from the host computer location. This patent explores the motivation for USB usages: connection, ease of use, and port expansion.

U.S. Pat. No. 7,054,983 discloses a USB hub device by commonly using a serial interface engine of a hub device. The USB hub device may include a hub address register, a human interface device (“HID”) address register, a first comparator, a second comparator, a virtual port control unit, or an HID request processing unit. This USB hub device may include an up port and down port.

U.S. Pat. No. 7,038,665 relates to an integrated input device communicating with a host computer system in accordance with the low-speed USB specification. The integrated input device includes a keyboard and a mouse. The keyboard and mouse have a function controller for providing output signals to a host computer or an upstream hub using a single USB low-speed cable and a USB type A connector.

For USB product development, U.S. Pat. No. 6,934,793 discloses a computer accessory device called a “USB sharer” for use with an external USB device. The USB sharer includes a multiplexer, which is connected to a computer host, an HID chip, which is connected to one output end of the multiplexer, a device output end, which is connected to another output end of the multiplexer, and a busyness detection module, which is connected to the middle of the HID chip and the device output end.

A USB hub is no longer simply a space for a memory stick. A USB hub is becoming a more and more complicated computerized device. The inside structure of a USB hub is complicated and can allow for performance of more computerized functions; however, there is no input/output command operation function inter-structured with devices having USB hubs yet.

All of the above use USB ports or chips simply as a device to be used with another different device. These arrangements are mere aggregates of simply one device with another device. They do not develop a cabled or wireless computerized input device with a combined computerized hub system inside for more comprehensively computerized input or output command operations.

### SUMMARY OF THE INVENTION

It is therefore an object of this invention to develop a computerized multiple input/output command operation system with a combined computerized hub system and wireless communication hub.

These and other objectives are achieved, according to the invention, by a computerized multiple input/output command operation system combined with a computerized hub system and cabled or wireless communication functions and methods. The computerized multiple input/output command operation system basically includes a computerized input device, such as a mouse, a computerized hub system, such as a USB hub, and a wireless communication hub built inside the computerized input device, a computerized host device, a wireless I/O device, and a computerized hub system driven extension for dual or multiple I/O computerized communications simultaneously and synchronously.

The computerized hub system carries multiple computerized hub system units. Those multiple computerized hub system units are contained within the computerized input device for multiple input and output functions such as memory space, adapter, connector, central processing unit (“CPU”), micro circuit board, wireless transmitter, power supplier (rechargeable), and multiple communication functions.

Generally speaking, the computerized hub system and wireless communication hub contained within the computerized input device together becomes a mini computerized cabled or wireless communication/command center. The computerized input device not only has computerized hub system ports inside for computerized hub system devices plugged in or out, but also use the computerized hub system ports and wireless communication hub to create a mini computerized communication command center by communicating with a computerized hosting device and a wireless I/O device simultaneously and synchronously for multiple computerized input/output system and all computerized hub system driven extensions such as a multiple player, a cellular/satellite communicator, any USB driver of CPU, a memory card, a notebook computer, a desktop computer, a personal digital assistant (“PDA”), a display device, an output device or printer, a digital camera, a USB stick, a USB wireless transmitter, a battery recharger, a computer or internet network, a television (“TV”) set/home electronics, any personal electronics, a power supplier, other USB hub, and private identification (“ID”) key with photo and finger print check functions, etc.

The present invention advantageously uses a computerized input device with a computerized hub system inside not only for its traditional functions, but also for multiple I/O command operations and communications simultaneously and synchronously.

Another advantage of the present invention is that it may use a wireless or cabled computerized input device with a computerized hub system and a wireless communication hub inside, not only for computerized pointing input function and computerized hub system functions, such as a computerized hub system driven adapter, peripheral, memory space, or connector, but also for multiple I/O command operations and communication among the computerized input device, the computerized hub system, the wireless communication hub and the computerized host device.

An advantage of the present invention is that it may use a wireless or cabled computerized input device with a computerized hub system and wireless communication hub inside, a wireless I/O device, not only for computerized pointing input functions and computerized hub system functions such as a USB driven adapter, peripheral, memory space, or connector, but also for multiple I/O devices, central processing unit (“CPU”) or memory processing operations, commands, and communication among the computerized input device, the computerized hub system, the wireless communication hub, the wireless I/O device, and the computerized host device simultaneously and synchronously.

Another advantage of the present invention is that it may use a wireless or cabled computerized input device with the computerized hub system and the wireless communication hub inside, the wireless I/O device, the computerized host device, and a computerized hub system driven extension, not only for computerized pointing input functions and computerized hub system functions, such as a USB driven adapter, peripheral, memory space, or connector, but also for multiple I/O devices, CPU/memory processing operations, commands, and cabled/wireless communications among the computerized input device, the computerized hub system, the wireless communication hub, the wireless I/O device, the computerized host device, and computerized hub system driven extension simultaneously and synchronously.

An advantage of the present invention is that it may use a wireless or cabled computerized input device with a computerized hub system and the wireless communication hub inside, a wireless I/O device, a computerized host device, and a computerized hub system driven extension, to create multiple mini computerized command networks and centers. Those command networks and centers are not only for computerized pointing input functions and computerized hub system functions such as a USB adapter, peripheral, memory space, or connector, but also for multiple I/O devices, CPU/memory processing operations, commands, and cabled/wireless communications among the computerized input device, the computerized hub system, the wireless communication hub, the wireless I/O device, the computerized host device, and the computerized hub system driven extension simultaneously and synchronously any time and any place.

Another advantage of the present invention is that it may use a computerized hub system not only for a computerized hub system driven adapter, peripheral, memory space, or connector, but also for multiple I/O devices, CPU/memory processing operations, commands, and cabled/wireless communications among the computerized input device, the computerized hub system, the wireless communication hub, the wireless I/O device, the computerized host device, and the computerized hub system driven extension at any time and any place.

An advantage of the present invention is that it may use a wireless communication hub for wireless communications and commands among a computerized input device, a computerized hub system, a wireless communication hub, a wireless I/O device, a computerized host device, and a computerized hub system driven extension.

Another advantage of the present invention is that it may use a wireless I/O device for wireless communications and commands to a computerized input device, a computerized hub system, a wireless communication hub, a computerized host device, and a computerized hub system driven extension for a multiple I/O system.

An advantage of the present invention is that it may use a wireless I/O device, together with a computerized input device having a computerized hub system and a wireless communication hub inside, for wireless and/or cabled communications and commands to a computerized host device and a computerized hub system driven extension for a multiple I/O system.

Another advantage of the present invention is that it may use a wireless I/O device, together with a computerized input device that has a computerized hub system and a wireless communication hub inside, for wireless or/and cabled communications and commands to the computerized host device, and a computerized hub system driven extension for multiple I/O system and multiple I/O command operation system or center simultaneously and synchronously any time and any place.

An advantage of the present invention is that it may use a computerized host device for cabled/wireless communications and commands/processes among a computerized input device, a computerized hub system, a wireless communication hub, a wireless I/O device, and a computerized hub system driven extension to create multiple mini computerized command networks and centers. Those command networks and centers are not only for computerized pointing input functions and computerized hub system functions, such as a USB adapter, peripheral, memory space, or connector, but also for multiple I/O devices, CPU/memory processing operations, commands, and cabled/wireless communications among the computerized input device, the computerized hub system, the wireless communication hub, the wireless I/O device, a computerized host device, and the computerized hub system driven extension simultaneously and synchronously.

Another aspect of the present invention is to create a computerized hub system driven extension for multiple mini computerized command networks and centers. Those command networks and centers are not only for computerized pointing input functions and computerized hub system functions, such as a USB adapter, peripheral, memory space, or connector, but also for instantly and simultaneously multiple I/O devices, CPU/memory processing operations, commands, and cabled/wireless communications among a computerized input device, a computerized hub system, a wireless communication hub, a wireless I/O device, a computerized host device, a computerized hub system driven extension, such as multiple player, cellular/satellite communicator, any USB driver of CPU, a memory card, a notebook computer, a desk computer, a PDA, a display device, an output device or printer, a digital camera, a USB stick, a USB wireless transmitter, a battery recharger, a computer or internet network, a TV set/home electronics, any personal electronics, a power supplier, another computerized hub system, and private ID key with photo and finger print check functions, etc.

### BRIEF DESCRIPTION OF THE DRAWINGS

Other objects and features of the present inventions will become apparent from the following detailed description considered in connection with the accompanying drawings. It is to be understood, however, that the drawings are designed as an illustration only and not as a definition of the limits of the inventions.

In the drawings, wherein similar reference characters denote similar elements throughout the several views:

FIG. 1 illustrates a computerized multiple I/O command operation system combined with a computerized input device, a computerized hub system with computerized hub ports and units, and a wireless communication hub for cabled or wireless communication functions and methods.

FIG. 2 shows one example of the workflow of a computerized multiple I/O command operation system including a computerized input device, a computerized hub system containing computerized hub system ports and computerized hub system units, the wireless I/O device, and a computerized host device.

FIG. 3 shows a traditional prior art I/O device or system. Traditionally, the workflow of a computer usage line is like a straight single down line from a power supplier, to a keyboard and a mouse, to a personal computer (“PC”), to a video display, and then to the end output of a printer, etc.

FIG. 4 shows the multiple workflow of a computerized multiple I/O command operation system, including a computerized input device, a computerized hub system, a wireless I/O device, and a computerized host device achieved in parallel and/or crossover at the same time.

FIG. 5 shows another embodiment of present invention for a computerized multiple I/O command operation system. A computerized input device can be used to to structure a mini computer task with a multiple I/O system.

FIG. 6 shows another embodiment of present invention. A computerized input device can be used to structure a mini network center task like a network chain with multiple I/O network systems for multiple networked computer engines and I/Os operating simultaneously and synchronously.

FIG. 7 shows another embodiment of present invention. The computerized input device can be used to structure a mini PDA set center with multiple I/O command functions and tasks or systems.

FIG. 8 shows an interface or pop-up menu for the functions of a computerized multiple I/O command operation system in accordance with an embodiment of the invention.

All solid lines represent a cable connection. All stitch lines represent a wireless connection using the wireless communication hub.

### DETAILED DESCRIPTION OF THE INVENTION

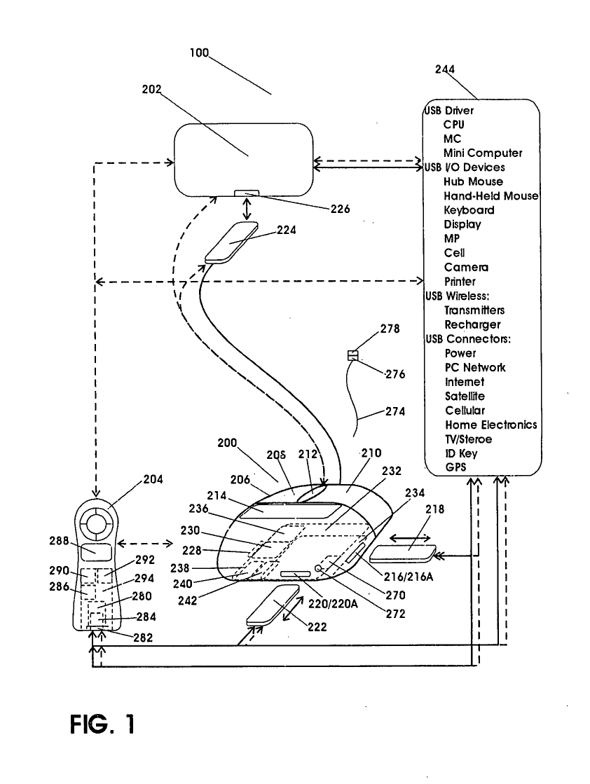

Turning now in detail to the drawings, reference first will be made to FIG. 1. The computerized multiple input and output command operation system 100 includes a computerized input device 200, a wireless I/O device 204 that can connect wirelessly to computerized input device 200, a computerized host device 202 that is connected to computerized input device 200, and a plurality of computerized hub system driven extensions 244 that are also connected to computerized hub system 234 inside computerized input device 200. Computerized input device 200 enables communications and multiple I/O functions instantly, simultaneously, and synchronously among computerized input device 200, computerized host device 202, wireless I/O device 204, and a plurality of computerized hub driven extensions 244.

Wireless I/O device 204 may be a wireless mouse, a wireless pointer, a wireless handheld controller, a handset, a cell phone, a multiple player, a TV/DVD/home electronic controller, satellite or cellular or Internet communicator, PDA, etc. There may also be a removable or installed computerized hub system unit 280 inside wireless I/O device 204. All the figures show wireless I/O device 204 as a wireless handheld controller.

Computerized host device 202 may be a computer (desktop or laptop), a PDA, an internet network, a cellular or satellite communicator, etc. All the figures show the computerized host device 202 as a computer.

Computerized input device 200 itself has a shell unit 206 with an outside, an inside, and at least one opening on said outside; a circuit board 232 on the inside; a wireless communication hub 238 that is attached to circuit board 232; a computerized hub system 234 that is also attached to circuit board 232; a port 216/220 from computerized hub system 234 that is contained within the opening of shell unit 206; and a plurality of computerized hub system units 218/222 that are removably connected to ports 216/220. Computerized input device 200 can be any kind of input device such as a mouse, a keyboard, a joystick, a handset, an arrow disc for remote I/O multiple control, process, and communication functions. All the figures show the computerized input device 200 as a mouse that additionally has a left click unit 208, a right click unit 210, a wheel unit 212, a display or screen unit 214 (“hub mouse”). Hub mouse 200 also has independently traditional mouse input functions.

At the top end side of hub mouse 200, there is cabled or wireless USB unit 224 that connects to computer's 202 USB port 226. Cabled or wireless USB unit 224 and USB port 226 carry out communication systems or methods among hub mouse 200, computer 202, wireless handheld controller 204, and USB hub 234 for multiple input and output functions, commands, data creation, operation, or storage. The cabled USB unit 224/226 may work with wireless communication hub 238.

Computerized hub system 234 in the computerized input device may be a peripheral component interconnect (“PCI”) card hub, a small computer system interface card (“SCSI”) hub, a local area network (“LAN”) hub, an ethernet hub, a USB hub, or a firewire hub. FIG. 1 shows computerized hub system 234 as USB hub, computerized hub system ports 216/220 as USB ports, computerized hub system units 218/222 as USB units, and computerized hub system driven extensions 244 as USB driven extensions. USB hub 234 controls the USB ports 216/220 and external or internal USB units 218/222.

At the side of hub mouse 200, there is USB port I 216 for an I/O device. An external or internal USB unit I 218 works for USB port I 216. USB unit I 218 can be plugged on or pushed wholly inside the USB port I 216 for storage 216A. There is another USB port II 220 at the side of hub mouse 200. The USB ports 216/220 can be arranged in any place related to each other or not. Port 216 can be programmed as Level A port and port 220 can be programmed as Level B port. Another external or internal USB unit II 222 works for the USB port II 220. USB unit II 222 can be plugged on or pushed wholly into inside USB port II 220 for storage 220A. There may be more USB ports or USB units (not shown) available, if needed.

Wireless communication hub 238 includes one or two or more wireless communication transmitters 240 and 242, which may be chip-style or portable USB style. Wireless communication transmitter 240 is designed for communications from hub mouse 200 and wireless handheld controller 204 to computer 202 when wireless handheld controller 204 can still directly or individually work with computer 202, hub mouse 200, and/or USB hub 234. Communication transmitter 242 is designed for the instant, simultaneous, and synchronous communications among hub mouse 200, USB hub 234, and computer 202.

There is a selection unit (not shown) that turns transmitter 240 or 242 on or off. Transmitters 240 and 242 can be removable as external or internal device. Transmitters 240 and 242 may be combined into one with dual or multiple transmitting functions.

USB units 218 and 222 may work as cabled or wireless converter and transmitter among computer 202, hub mouse 200, wireless handheld controller 204, and USB driven extension 244 such as TV/DVD/Stereo or Internet or Cellular/Satellite Communicator, etc.

The computerized multiple input/output system 100 structured as a mini computer command network center, is not only for connection or memory storage/transfer, but also, more importantly, for simultaneously and synchronously multiple input/output command operation center networking hub mouse 200 with a built-in USB hub 234 and wireless communication hub 238 inside, computer 202, wireless handheld controller 204, and USB driven extensions 244. Because USB ports are not only for memory and space, USB unit 234 including USB ports 216/220 and units 218/222 are also for I/O command functions utilized micro CPU/memory capacity. Therefore, hub mouse 200 is designed and structured with five basic computer units: I/O units (input unit 200 itself and output units 216/220), monitor 214, motherboard 232, CPU 236, and memory unit 228/230, in order to operate as a mini computer.

A memory hub unit 228 is also located at the side of hub mouse 200 to work with a removable external or internal memory unit 230. Memory hub unit 228, USB hub 234, wireless communication hub 238 may be combined into one hub system if needed.

A CPU 236 may be installed inside hub mouse 200. More CPUs may be added internally or externally on any hub unit if needed. CPU 236, memory unit 230, and motherboard 232 can be any kind of super micro chip, or combined into one extremely small micro chip.

Therefore, the dual or multiple input functions are achieved among hub mouse 200, USB hub 234, wireless communication hub 238, wireless handheld controller 204, and computer 202. In other words, the dual input devices 200 and 204 can simultaneously and synchronously input any commands or data into computer 202. Actually, hub mouse 200 and wireless handheld controller 204 can simultaneously and synchronously control one cursor or more cursors on the screen of computer 202. Finally, the dual input units 200 and 204 can simultaneously and synchronously work with USB hub 234 for multiple input/output any commands or function or operation or data into/from computer 202 with cabled or wireless communication functions.

Wireless communication hub 238 also works for USB hub 234 functions at the same time to carry out wireless communication systems or methods among hub mouse 200, wireless handheld controller 204, USB units 218/222, and computer 202 for multiple input and output functions or commands or data creation or operation or storage. For example, USB unit I or II 218 or 222 under USB hub 234 can input or output or operate computerized functions, drivers, commands or digitalized data through hub mouse 200 to computer 202. Hub mouse 200 can transfer those USB I/O device functions, commands, or digitalized data into or from computer 202 and wireless handheld controller 204 through wireless communication hub 238 or cabled method 224.

USB units 218/222 can work with or contain any digitalized I/O driver or unit or function as USB driven extension 244 such as multiple player, cellular/satellite communicator, any USB driver of CPU, memory card, or notebook computer, or desk computer, PDA, display device 250, output device or printer 252, digital camera, USB stick, USB wireless transmitter, battery recharger, computer or internet network, TV set/home electronics, any personal electronics, power supplier, another USB hub 234B, and private ID key with photo and finger print check functions, GPS system, etc.

The USB units 218/222 are for the USB extension functions of hub mouse 200. USB unit 224 is for the communication function between the hub mouse 200 and the computer unit 202 through the computer USB port 226. The USB unit 224 can be cabled or wireless.

USB unit 218/222 can also be directly connected into the port 226 of the computer 202 and/or even into the handheld controller 204 if needed. At the same time, the cabled or wireless USB unit 224 of hub mouse 200 can be directly connected into the handheld controller 204 if desired to achieve digitalized single or dual or stereo input/output technology simultaneously and synchronously.

Hub mouse 200 has a battery recharge function unit 270 and a recharge jet 272. There is a recharge cable 274 and recharge head 276. Recharge cable 274 can be internally hidden inside hub mouse 200 or as an independent extension cord. Recharge head 276 contains a multiple connector 278 for different battery recharge usages such as wireless handheld controller 204, cellular/satellite phone (communicator), internet communicator, wireless earphone, multiple player, and portable electronics, etc. The USB recharge 276 has different switchable recharge functions for 3.5V lithium batteries used for cellular phones, multiple player and for AA/AAA batteries and/or any kind battery. Battery recharge jet 272 may be replaced with a USB recharge jet or combined into a USB driven extension 244 for battery recharge.

Any kind of combination of hub mouse 200, computer 202, wireless handheld controller 204, and USB hub 234 with all USB driven extensions 244 may be workable to structure another new version of a computerized multiple input/output command operation system 100.

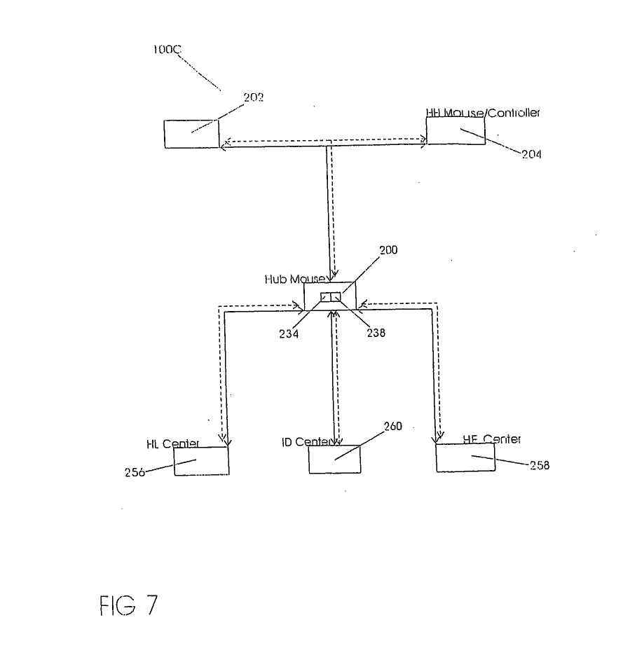

Hub mouse 200, wireless handheld controller 204, and USB hub 234 can independently or directly work with computer 202. Hub mouse 200 with USB hub 234 inside has multiple I/O command operation functions to computer 202 simultaneously and synchronously. Hub mouse 200 having USB hub 234 and wireless communication hub 238 inside and wireless handheld controller 204 can also independently or directly work with the computer 202 for USB driven extensions such as TV/DVD and any home electronics 244 and 256/258/260 (shown on FIG. 7).

Hub mouse 200 with USB hub 234 and wireless communication hub 238 inside has multiple I/O command operation functions to computer 202 and/or wireless handheld controller 204 simultaneously and synchronously. Hub mouse 200 working with wireless handheld controller 204 can achieve dual I/O command operation functions to computer 202 simultaneously and synchronously.

Hub mouse 200 with wireless communication hub 238 inside operates with handheld controller 204 together for multiple I/O command operation functions to computer 202 and USB driven extensions 244 simultaneously and synchronously with cabled and/or wireless communication functions.

Hub mouse 200 with USB hub 234 and wireless communication hub 238 inside operates with wireless handheld controller 204 together for multiple I/O command operation functions to computer 202 and USB driven extensions 244 simultaneously and synchronously in parallel and/or cross-over with cabled and/or wireless communication functions.

Wireless handheld controller 204 can wirelessly communicate with computer 202 and/or hub mouse 200 for I/O functions by using wireless communication hub 238 and/or sharing USB unit/port 224/226/280 or using another set of USB unit/port (not shown).

There may be a removable or installed USB unit 280 inside wireless handheld controller unit 204.

There is a USB hub unit 284 inside wireless handheld controller 204. USB hub unit 284 which is inside wireless handheld controller unit 204 contains a USB port 282 and a USB unit 280. The function of USB unit 280 is the same as USB units 218 and 222. The function of USB port 282 is the same as USB port 216/220. USB unit 280 is interchangeable or replaceable with USB units 218 and 222. Therefore, wireless handheld controller 204 has an independent USB hub system or same as the hub system of hub mouse 200 if needed. In other words, the USB units 280/282/284 can be interchanged with the USB unit 216/218/220/222/234 for extension functions 244 between the hand held controller 204 and hub mouse 200.

There is also a wireless communication unit 286 inside wireless handheld controller 204.

There is a display unit 288 on handheld controller 204. Also, there can be a CPU 290, a memory unit 292, a mother board 294 inside handheld controller 204.

The design, size, location, method, shape, and material of hub mouse 200, computer 202, wireless handheld controller 204, wireless communication hub 238, USB hub 234, and USB ports/units 220/218/222 may vary.

Hub mouse 200 and wireless handheld controller 204 may be used a mechanical movement sensor/detector, or an optical movement sensor/detector, or a laser movement sensor/detector with ball (ball/click) structure or flat surface touchable structure or stick/click/button/arrow structure for X- & Y- &/or Z- cursor movements and I/O commands on the screen of computer 202 or USB driven extensions 244.

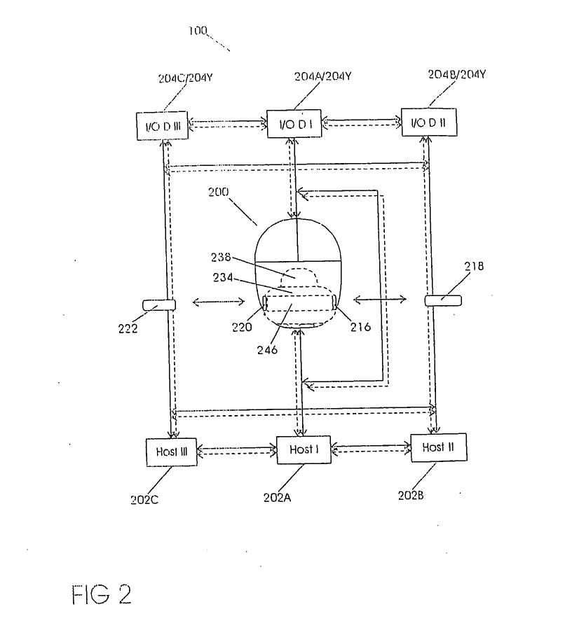

FIG. 2 shows hub mouse 200 that contains USB ports I/II 216/220 working with removable USB units I/II 218/222 under or within USB hub 234. USB units I/II 218/222 can communicate or operate through hub mouse 200 into computer I 200A or/and the wireless handheld controller I 204A.

Hub mouse 200 can communicate with the wireless handheld controller 204A with or without using USB hub 234.

Hub mouse 200 can communicate with computer I 202A with or without USB hub 234.

There is a USB storage room 246 for storing USB unit 218 or 222 inside hub mouse 200.

Furthermore, USB units I/II 218/222 under USB hub 234 within hub mouse 200 can directly work with other computers II/III 202B/C connecting or disconnecting (in parallel and simultaneously) with computer I 202A. As individual or group I/O drivers, the other wireless handheld controller II/III 204B/C connecting or disconnecting the wireless handheld controller I 204A can work with computers I/II/III 202A/B/C by using wireless communication hub 238 and/or USB units I/II 218/222 under USB hub 234 within hub mouse 200 in parallel and simultaneously.

USB units I/II 218/222 can be replaced with any kind of I/O device.

The wireless handheld controller I/II/III 204A/B/C can be replaced with any kind of I/O device, driver, converter or transmitter 204Y.

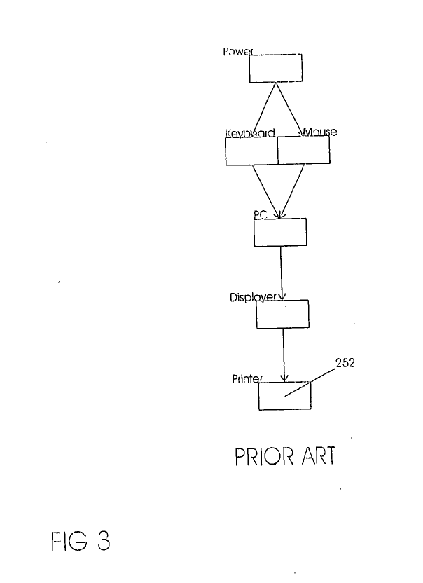

FIG. 3 shows a traditional prior art input/output device or system. Traditionally, the workflow of a computer usage line is like straight single down line from a power supplier, to a keyboard and regular mouse with Personal System/2 (“PS/2”) port or USB port, to a PC, to a video display, and then to the end output of a printer, etc.

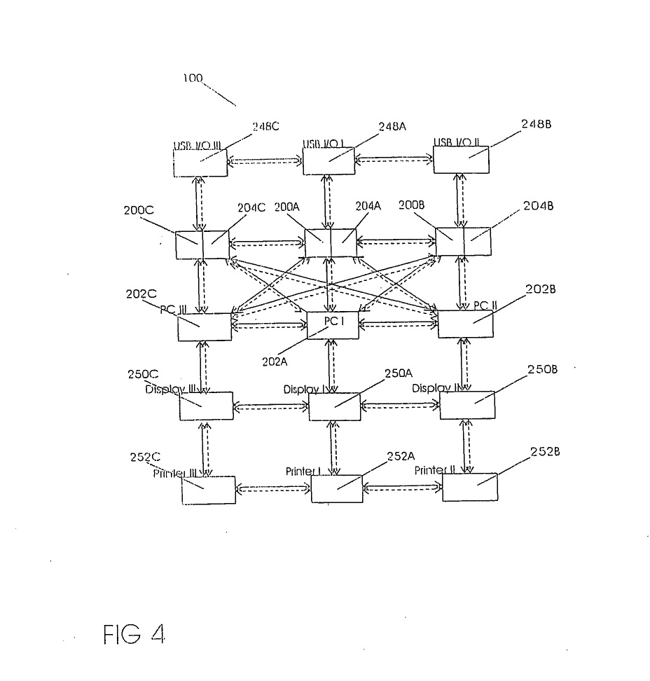

FIG. 4 discloses the multiple workflow of a computerized multiple input/output command operation system 100 including hub mouse 200, USB hub 234, wireless handheld controller 204, and computer 202 achieved in parallel and/or crossover at the same time. Hub mouse I 200A can in parallel work with other hub mouse II/III 200B/C and USB I/O unit I 248A through the USB hub 234 when hub mouse I 200A and wireless handheld controller I 204A dually work with computer I 202A for dual or multiple input/output functions such as controlling the cursor X-Y movements and commands on the display device I 250A and for output commanding of the output device I 252A. At the same time, hub mouse II/III 200B/C and wireless handheld controller II/III 204B/C can do the same thing in parallel or cross-over through USB hub 234 B/C for USB I/O devices II/III 248B/C to computer II/III 202B/C for dual or multiple input functions such as controlling the cursor X-Y movements and commands on display device II/III 250B/C and for output commanding of output device II/III 252B/C.

Furthermore, through ID code system of each I/O device, hub mouse I/II/III 200A/B/C and wireless handheld controller I/II/III 204 A/B/C can work individually and straightly one by one for each computer I/II/III 202A/B/C with each display device I/II/III 250A/B/C and output device I/II/III 252A/B/C. Alternatively, hub mouse I/II/III 200A/B/C and wireless handheld controller I/II/III 204 A/B/C can work in parallel and simultaneously cross-over each other for one or two or three or more computers I/II/III 202A/B/C with each display device I/II/III 250A/B/C and output device I/II/III 252A/B/C.

Thus, multiple input sources, plus multiple I/O hub units, plus multiple computers, displays, and output devices, are structured for the achievement of parallel, simultaneous, straight and/or cross-over operations with the cable or wireless communication hub 224/238.

Display device 250A/B/C can be any kind digital screen output device such as a monitor, moving pictures experts group-1, audio player 3 (“MP3”) player, cellular/satellite communicator, Internet network, PDA, etc., like indicated I/O extensions 244 (shown on FIG. 1).

Output device 252A/B/C can be any kind digital data output device like indicated I/O extensions 244 (shown on FIG. 1), such as a printer, an MP3 player, a cellular/satellite communicator, an internet network, a PDA, etc.

This achievement is very useful for multiple I/O device driver tasks or network multiple operations 244 (shown on FIG. 1) which require simultaneous, parallel, and cross-over communications, especially for education, network, conference, entertainment, game, or satellite/cellular/internet communications.

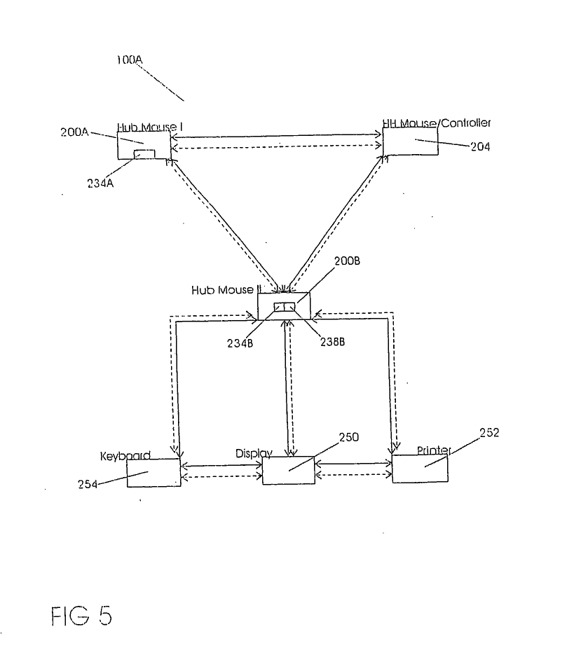

FIG. 5 shows another embodiment of present invention for a computerized multiple input/output command operation system 100A. Hub mouse I/II 200A/B can work together to create a mini computerized system with a multiple I/O system. Hub mouse I 200A and wireless handheld controller 204 are still dual input devices. Hub mouse II 200B becomes a PC engine unit using CPU 236, memory hub unit 228, display unit 214 (or external one), and USB hub 234 to substitute computer 202. Keyboard unit 254, display device 250 and output device 252 may be added to work with hub mouse I/II 200A/B to complete a set of mini computer with multiple I/O systems.

Hub mouse II 200B is located at the center to operate with circuit board 232, CPU unit 236, memory hub unit 228 contained within hub mouse II 200B. CPU unit 236, memory hub unit 228, and wireless communication hub 238 can also be internal/external USB styled units through the hub system unit 234B and wireless communication unit 238B. Hub mouse I 200A and handheld controller 204 are operated together and/or individually for dual and/or single input functions to hub mouse II 200B. The keyboard unit 254 functions as a data typing input. The display unit 214 on hub mouse II 200B is used as a computer screen. Also, external display unit 250 can be connected to hub mouse II 200B through the USB hub system unit 234B and wireless communication hub 238B. The print unit 252 can be connected to hub mouse II 200B through USB unit 234B and wireless communication hub 238.

In that case, hub mouse II 200B is used as a computerized host device 202 for substituted computer functions. The mini computer system task 100A includes: hub mouse II 200B as a computer host function with a multiple I/O system, hub mouse I 200A and handheld controller 204 as a single or dual input function, keyboard unit 254 as data typing input function, USB hub unit 234B and communication unit 238B contained within hub mouse II 200B as a computer I/O connection function to the internal or external display unit 214/250, print unit 252, and an internet unit (not shown).

USB hub unit 234B and wireless communication hub 238B can be used as computer I/O ports to hub mouse II 200B internally or externally. USB hub unit 234B and communication unit 238B can provide a computer CPU and/or memory functions to hub mouse 200 II 200B internally or externally.

USB hub unit 234B and wireless communication hub 238B can be used as a cabled or wireless communication hub to hub mouse II 200B internally or externally.

Hub mouse II 200B can be designed differently from the design of hub mouse I 200A or like a PDA/Cell Phone style or any kind shape and design.

Hub mouse I & II 200A/200B are replaceable or interchangeable with each other at the same time if needed. Furthermore, hub mouse I & II 200A/ 200B and handheld controller 204 are replaceable or interchangeable with each other at the same time if needed. Beside the mouse I 200A and handheld controller 204, more additional hub mice and handheld controllers can be added and structured around the hub mouse II 200B for multiple users and players simultaneously and synchronously, such as internet multiple players or educational users. For example, Mouse I 200A and handheld controller 204 can be used by a teacher in his class. Mouse II 200B can be used as a computerized network center or center computer (main frame) to hub or net additional mice and controllers used by his students with or without sequenced mouse numbers or IDs simultaneously and synchronously for multiple I/O cabled or wireless functions in a classroom.

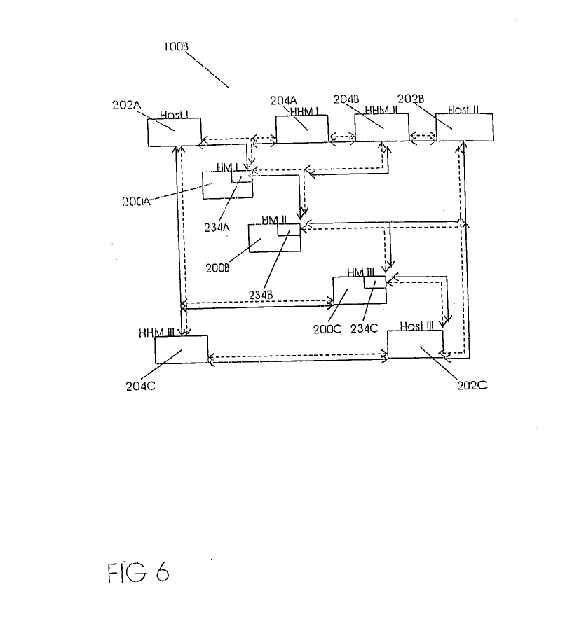

FIG. 6 shows another embodiment of the present invention. Hub mouse I/II/III 200A/B/C can work together to structure a mini network center task 100B like a network chain with multiple I/O network system for multiple networked computer engines and I/Os operating together simultaneously and synchronously. With adjustable ID selection of each input/output device, hub mouse I 200A and USB hub 234A works with computer I 202A and wireless handheld controller I 204A by hubbing wireless handheld controller I 204A with the wireless handheld controller II/III 204B/C and hub mouse II/III 200B/C connecting computer II/III 202B/C as a network. Additional I/O devices like indicated USB driven I/O extensions 244 can be added through USB hub I/II/III 234A/B/C inside hub mouse I/II/III 200A/B/C for additional network extensions.

FIG. 7 shows another embodiment of the present invention. Hub mouse 200 can be used to structure a mini PDA set center with multiple I/O command functions and tasks or systems 100C. Hub mouse 200 can work for computer 202 as an I/O device with USB hub 234 and 238. The wireless handheld controller 204 works for computer 202 as second I/O device, and wireless handheld controller 204 can wirelessly communicate with the hub mouse 200, computer 202 and other I/O devices.

Hub mouse 200, wireless handheld controller 204, USB hub 234, computer 202, and USB driven extensions 244 can work simultaneously and synchronously to control input/output functions for communications with home living units 256. Home living units 256 include home entertaining units 258, and personal or private information units 260, such as kitchen electronics, light control unit, wash and dry machine unit, etc. Home entertaining units 258 include TV sets, digital camera unit, stereo units, etc. Personal or private information units 260 include personal ID, personal data assistant, finger print ID, photo ID for bank business, passport, health protection, and security protection, etc.

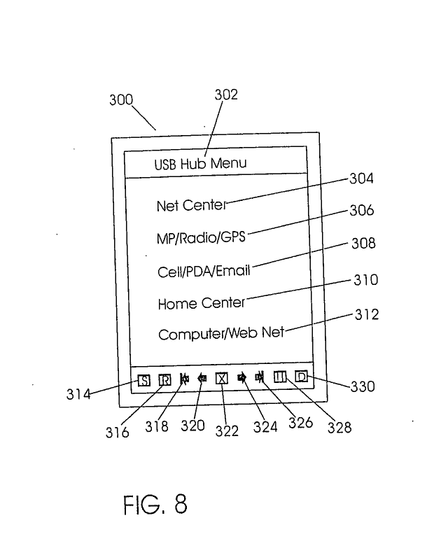

FIG. 8 shows an interface or pop-up menu 300 when USB hub 234 of hub mouse 200 (shown on FIG. 1) is activated. Pop-up menu 300 can be opened automatically or manually with or without an on/off selection. Pop-up menu 300 contains a USB Hub Menu 302. USB Hub Menu 302 contains many USB hub system functions that coorespond to USB extensions 244 connected to USB hub 234, such as a net center menu 304, MP/Radio/GPS menu 306, cell/PDA/email menu 308, home center menu 310, computer/web net menu 312. Those menus contain their own sub-menus.

Net center menu 304 establishes a computerized network system through the USB ports and units 216/218/220/222 of USB hub 234 of hub mouse 200 and wireless communication hub 238 of hub mouse 200 to computer host 202 and handheld controller 204 externally or internally, individually or systematically.

The MP/Radio/GPS menu 306 plays digitalized music/radio/GPS through USB ports and units 216/218/220/222/280/282/234/284 of the USB hub and wireless communication hub 238/286 of hub mouse 200 and the handheld controller 204 and computer unit 202 externally or internally and individually or systematically. When MP/Radio/GPS menu 306 is clicked, there are two sub-menus MP/Radio and GPS system from which a user can choose which one he likes to play.

The Cell/PDA/Email menu 308 controls the functions of a cellular phone, PDA and/or email communicator that are connected to USB ports and units 216/218/220/222/280/282 and wireless communication hub 238/286 of USB hub 234/284 of hub mouse 200 and handheld controller 204 and computerized host device 202 externally or internally, individually or systematically. When the Cell/PDA/Email 308 is clicked, there are three sub-menus cell, PDA, and email to show up for a user to choice which one he would like to use.

Home center menu 310 accesses home computerized electronics such as TV, DVD, Stereo, Kitchen, Laundry, Light System, and Security System for home entertainments and house works through the USB ports and units 216/218/220/222/280/282 of USB hub 234 and wireless communication hub 238/286 of hub mouse 200 and handheld controller 204 and computer unit 202 externally or internally, individually or systematically.

The computer/web net menu 312 links with computer networks or internet web systems through USB ports and units 216/218/220/222/280/282 of the USB hub 234 and wireless communication hub 238/286 of the hub mouse 200 and handheld controller 204 and computerized host device 202 externally or internally, individually or systematically. When the computer/web net 312 is clicked, there are two menus, Computer Network and World Wide Web Network, from which a user can choose which one he would like to get.

The design, shape, location, names, contains of those menus 300/302/304/306/308/310/312 may vary if needed, such as graphic interface style, letter style, touchable style, or symbolized interface style, etc.

There are many play function keys from 314 to 330 under the Menu 300. The key 314 has a save function. The key 316 has a reverse play function. The key 318 has a go-back to the beginning function. The key 320 has a go-back function. The key 322 has a close function. The key 324 has a go-forward function. The key 326 has a go-forward to the end function. The key 328 has a pause function. The key 330 has a delete function.

All those play function keys from 314 to 330 may be re-designed or re-arranged if needed. The shape and design and location and function of those play function keys from 314 to 330 may vary.

Menu 300 may show up on the display screen of computerized host device 202, and/or display unit 214 of hub mouse 200, and/or display unit 288 of handheld controller 204, and/or any computerized display unit.

Although several embodiments of the present invention have been shown and described, it is apparent that many changes and modifications may be made thereunto without departing from the spirit and scope of the invention.

What is claimed is:

1. A computerized multiple input and output command operation system comprising:
a) a computerized input device comprising:
i) a shell unit having an outside, an inside, and at least one opening on said outside;
ii) a circuit board on said inside;
iii) a computerized hub system attached to said circuit board wherein a port from said computerized hub system is contained within each said opening;
iv) a computerized hub system unit, wherein a computerized hub system unit is connected to said port; and
v) a wireless communication hub attached to said circuit board;
b) a wireless input/output device wherein said input/output device connects wirelessly to said wireless communication hub; and
c) a computerized hub system driven extension that is attached to said computerized hub system unit, wherein said computer hub driven extension communicates through said computerized hub system multi-directionally to said computerized host device, said computerized input device, and said wireless input/output device; wherein said computerized input device enables instantaneous, simultaneous, and synchronous communications of multiple input/output operations among said computerized input device, said computerized host device, said wireless input/output device, and said computerized hub driven extension.

2. The computerized multiple input and output command operation system of claim 1, further comprising a computerized host device connected to said computerized input device.

3. The computerized multiple input and output command operation system of claim 2 further comprising:
a display device that is connected to said computerized host device,
wherein said computerized input device enables instantaneous, simultaneous, and synchronous communications of multiple input/output operations among said computerized input device, said wireless input/output device, and said computerized hub driven extension.

4. The computerized multiple input and output command operation system of claim 1, further comprising home living unit connected to said computerized hub system unit of said computerized input device, wherein said computerized input device enables instantaneous, simultaneous, and synchronous communications of multiple input/output operations among said home living unit, computerized input device, said wireless input/output device, and said computerized hub driven extension.

5. The computerized multiple input and output command operation system of claim 1, wherein said computerized host device is a computer, personal digital assistant, internet network, satellite communicator, or cellular communicator.

6. The computerized multiple input and output command operation system of claim 1, wherein said wireless input/output device is a mouse, a cell phone, a personal digital assistant, a global positioning system device, a remote control used with home electronics, an internet communicator, or a cellular communicator.

7. The computerized multiple input and output command operation system of claim 1, wherein the computerized input device is device is a mouse, a keyboard, a handheld controller, or a joystick.

8. A computerized input device for connection to a computerized host device, comprising:
a) a shell unit having an outside, an inside, and at least one opening on said outside;
b) a circuit board on said inside;
c) a computerized hub system attached to said circuit board wherein a port from said computerized hub system is contained within said opening; and
d) a plurality of computerized hub system units, wherein each computerized hub system units is connected to each said port.

9. The computerized input device of claim 8 further comprising a display unit connected to said circuit board of said inside and that is located on said outside of said shell unit.

10. The computerized input device of claim 8 further comprising a wireless communication hub attached to said circuit board.

11. The computerized input device according to claim 10 wherein said wireless communication hub comprises two wireless transmitters, wherein
a) said first wireless transmitter provides simultaneous and synchronous communication among said computerized input device, said computerized hub system, and said computerized host device; and
b) said second wireless transmitter provides simultaneous and synchronous communication among said computerized input device, at least one wireless input/output device, and said computerized host device.

12. The computerized input device according to claim 8, wherein said computerized hub system is a memory port, a peripheral component interconnect card hub, a small computer system interface card hub, a local area network hub, an ethernet hub, a universal serial bus hub, or a firewire hub.

13. The computerized input device according to claim 8 further comprising a battery recharge unit on said circuit board, said battery recharge unit further comprising a recharge jet, a recharge cable, and a recharge head with a multiple connector.

14. The computerized input device according to claim 8, wherein each said computerized hub system unit is removably attached to said port and can wirelessly communicate with said port.

15. The computerized input device according to claim 8, further comprising a central processing unit connected to said circuit board on said inside of said shell unit, and memory hub unit connected to said circuit board on said inside of said shell unit.

16. The computerized input device according to claim 8, wherein said computerized input device is a mouse, a keyboard, a handheld controller, or a joystick.

17. A method for operating computerized hub driven extensions connected to a computerized multiple input and output command operation system, the method comprising the steps of:
a) connecting at least one computerized hub driven extension to at least one computerized hub system port of said computerized multiple input and output command operation system;
b) activating a computerized hub system menu on at least one computerized input device that is connected to said computerized multiple input and output command operation system;
c) selecting a first submenu that corresponds to said at least one computerized hub system driven extension containing at least one command; and
d) selecting said command that corresponds to said at least one computerized hub driven extension.

18. The method according to claim 17, wherein the step of selecting a submenu that corresponds to said at least one computerized hub system driven extension containing at least one command further comprises selecting a last nested submenu after selecting through said first submenu and at least one intermediary nested submenu, wherein said at least one command is contained within said last nested submenu.

19. The method according to claim 17, wherein said first submenu is a plurality of said first submenus.

20. The method according to claim 19, wherein said plurality of said first submenus comprises a net center menu, a multiple player/radio/global positioning system menu, a cellular phone/personal digital assistant/electronic mail menu, a home center menu, and a computer/web net menu.
